(19) United States
(12) Patent Application Publication
(10) Pub. No.: US 2013/0303251 A1
(43) Pub. Date: Nov. 14, 2013

(54) SYSTEMS AND METHODS FOR FACILITATING CUSTOMER ACQUISITION FOR ADVERTISERS

(71) Applicant: Vincent Brown, Renton, WA (US)

(72) Inventor: Vincent Brown, Renton, WA (US)

(21) Appl. No.: 13/467,980

(22) Filed: May 9, 2012

(51) Int. Cl. A63F 13/00

(52) U.S. Cl. 463/17

(57) ABSTRACT

Customers participate in a raffle, the value of a raffle ticket purchase being returned to the customer as a voucher redeemable at different advertising merchants. Participation in this particular raffle provides the exciting possibility of winning a prize along with a perception of no risk in participating because the cost of buying a raffle ticket is fully rebated to the customer in the form of a voucher redeemable for purchases the customer was likely to make anyway. For merchants, in exchange for subsidizing a customer's participation in the raffle in the form of providing a discount on goods and/or services, merchants receive a customer highly motivated to purchase from the merchant. Merchants may thus consider the cost of subsidizing the raffle entries a significantly more effective advertising expenditure than traditional advertising as the expense is virtually assured to bring customers in the door who will spend money at their business.

### FIELD OF THE INVENTION

This invention relates generally to customer acquisition, and more specifically, to systems and methods for facilitating customer acquisition for advertisers.

### SUMMARY

In some embodiments, a method of facilitating customer acquisition for advertisers includes, but is not limited to, establishing agreements with one or more advertisers to partner in a raffle, the one or more advertisers desiring to acquire highly-motivated customers; establishing a raffle; selling a plurality of lots to one or more participants; issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot; accepting a payment from the one or more advertisers, the payment in exchange for issuing the vouchers; choosing a lot at random from the plurality of lots at the point in time when the raffle will end; designating the chosen lot as the winning lot; and awarding the prize to the participant holding the winning lot.

In some embodiments, a system for facilitating customer acquisition for advertisers includes, but is not limited to, circuitry for establishing agreements with one or more advertisers to partner in a raffle, the one or more advertisers desiring to acquire highly-motivated customers; circuitry for establishing a raffle; circuitry for selling a plurality of lots to one or more participants; circuitry for issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot; circuitry for accepting a payment from the one or more advertisers, the payment in exchange for issuing the vouchers; circuitry for choosing a lot at random from the plurality of lots at the point in time when the raffle will end; circuitry for designating the chosen lot as the winning lot; and circuitry for awarding the prize to the participant holding the winning lot.

In some embodiments, a system for facilitating customer acquisition for advertisers includes, but is not limited to, means for establishing agreements with one or more advertisers to partner in a raffle, the one or more advertisers desiring to acquire highly-motivated customers; means for establishing a raffle; means for selling a plurality of lots to one or more participants; means for issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot; means for accepting a payment from the one or more advertisers, the payment in exchange for issuing the vouchers; means for choosing a lot at random from the plurality of lots at the point in time when the raffle will end; means for designating the chosen lot as the winning lot; and means for awarding the prize to the participant holding the winning lot.

In addition to the foregoing, various other methods, systems and/or program product embodiments are set forth and described in the teachings such as the text (e.g., claims, APPENDIX A and/or the detailed description) and/or drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Embodiments of the present invention are described in detail below with reference to the following drawings:

FIG. 1 depicts an exemplary environment in which the methods and systems described herein may be represented;

FIG. 2 depicts a high-level logic flowchart of an operational process;

FIG. 3 depicts a high-level logic flowchart of an aspect of the operational process depicted in FIG. 2;

FIG. 4 depicts several alternative implementations of the high-level logic flowchart of FIG. 2;

FIG. 5 depicts several alternative implementations of the high-level logic flowchart of FIG. 2;

FIGS. 6A-6C depict several alternative implementations of the high-level logic flowchart of FIG. 2;

FIG. 7 depicts an alternative implementation of the high-level logic flowchart of FIG. 2;

FIG. 8 depicts an alternative implementation of the high-level logic flowchart of FIG. 2;

FIG. 9 depicts several alternative implementations of the high-level logic flowchart of FIG. 2; and

FIG. 10 depicts an alternative implementation of the high-level logic flowchart of FIG. 2.

### DETAILED DESCRIPTION

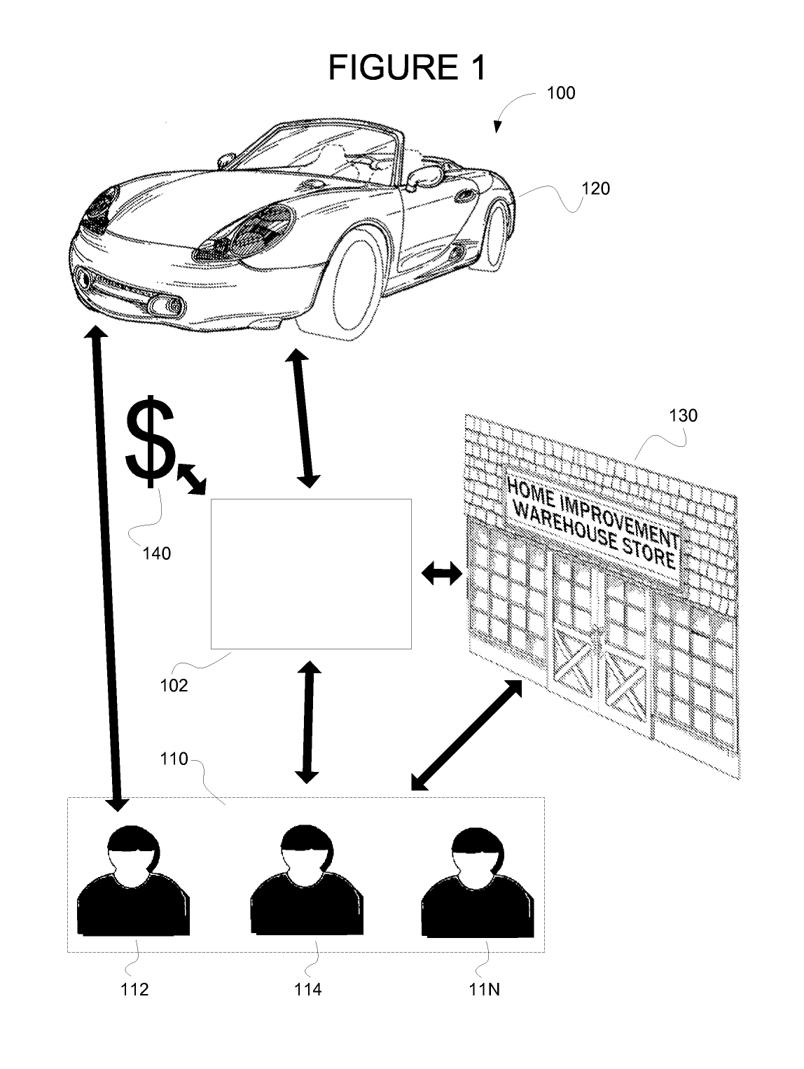

This invention relates generally to customer acquisition, and more specifically, to systems and methods for facilitating customer acquisition for advertisers. Specific details of certain embodiments of the invention are set forth in the following description and in FIGS. 1-10 and APPENDIX A to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 depicts an exemplary environment 100 in which the methods and systems described herein may be represented. In the exemplary environment 100, one or more participants in a raffle are depicted at 112 and 114. A raffle may have a particular number (where the particular number is represented as “N”) of participants, where a first participant is represented as 112, a second participant is represented as 114, and a further participant or participants are represented as 11N. A plurality of participants, the plurality of participants being one or more participants, is represented at 110. A participant may include but is not limited to a person and/or a group of persons.

In the exemplary environment 100, a participant 11N may desire to enter a raffle, the raffle having a prize 120. In some embodiments, a prize 120 may be a good, a chattel, an item of merchandise, or any tangible thing. In different embodiments, a prize 120 may be a cash prize. In certain embodiments, a prize 120 may be a lottery jackpot. In yet other embodiments, a prize 120 may be a service, a trip, an investment such as a savings bond, a combination of any of the above, or any other thing of value appropriate for a raffle, lottery or other game of chance.

In the exemplary environment 100, a raffle may be established and conducted by a system 106 according to an implementation of the systems and methods described herein. In some embodiments, one or more participants 110 transact with system 106 to enter the raffle being conducted by system 106 with a prize 120 being raffled by system 106. At the conclusion of a raffle, one participant, such as participant 112, will “win” the raffle and be awarded the prize 120.

Some potential participants in a raffle may be reluctant to enter due to the risk of paying for a raffle ticket which may not be the winning raffle ticket. In some embodiments, the risk that is perceived by a potential participant in a raffle may be mitigated by providing a potential participant something of value in addition to a chance of winning in exchange for entry into the raffle. If a potential participant feels that in addition to a chance at winning the raffle, the potential participant will also receive something else of value in exchange for paying for the raffle ticket, the potential participant may be more likely to enter a raffle. It logically follows that the more valuable the thing the potential participant would receive in addition to the entry into the raffle, the less risky the potential participant will perceive the entry into the raffle to be, and the more likely the potential participant will be to participate in the raffle.

In some embodiments, when a potential participant enters a raffle, the potential participant becomes a participant 11N, and in addition to the entry into the raffle the participant 11N may receive a voucher redeemable by an advertiser 130. The advertiser 130 may be a retail store, such as a home improvement warehouse store, where the advertiser 130 desires to acquire customers that are highly motivated to spend money with the advertiser 130. In some embodiments, the advertiser 130 may be a retail store, an online store, an airline, a hotel, a beauty salon, a certified public accountant, a financial services provider, or any other type of entity desiring to acquire customers that are highly motivated to spend money with the advertiser 130.

In some embodiments, an advertiser 130 desiring to acquire customers that are highly motivated to spend money with the advertiser 130 may elect to “subsidize” the participants' 11N entries into the raffle by agreeing to honor vouchers provided to the participants 11N redeemable with the advertiser 130. In certain embodiments, the participant 11N receives, in addition to an entry into the raffle, a voucher redeemable with an advertiser 130 that is equal in value to the cost of the raffle ticket. At the time of entry into the raffle, the participant 11N may elect a voucher for a particular advertiser 130 from a list of all advertisers 130 that have agreed to honor such vouchers.

As described by the foregoing, an advertiser 130 may consider the subsidy of the purchase of a raffle ticket by a participant 11N to be a significantly more effective manner of acquiring customers than traditional advertising venues. The advertiser 130 subsidizing the cost of a raffle ticket for a participant 11N by redeeming a voucher in the amount of the cost of the raffle ticket for the participant 11N is practically assured that the participant 11N will be motivated to visit the advertiser 130 and complete a transaction. In some embodiments, an advertiser 130 may make a payment in exchange for the facilitation of the acquisition of the highly motivated customer, the payment being received by the system 106.

In some embodiments, a raffle has a certain number of lots, each lot being one chance to win the prize. Ideally, all lots are sold prior to the prize being awarded, but this does not always occur. In certain embodiments, an insurance policy is acquired by the system 106 from an insurer 140 to manage the risk of not all lots being sold.

System 106 represents any system or entity capable of carrying out the methods disclosed herein. In some embodiments, system 106 may be implemented on one or more computers including one or more file, web, and/or database servers, but the embodiment of system 106 is not limited to such an implementation. The choice and manner of implementation of such servers is well known in the art and will be within the capability of those with skill in the art, and will not be discussed further herein. System 106 is illustrated in the exemplary environment in close physical proximity to the one or more participants 110, the advertiser 130, the prize 120 and the insurer 140. Those skilled in the art will appreciate that one or more of the devices and/or entities included in the exemplary environment 100 may be relatively distant from each other but operably coupled to other of the one or more devices and/or entities, or in physical proximity to the respective devices and/or entities with which system 106 is associated. A participant 11N, the advertiser 130, an insurer 140, and the supplier of a prize 120 may all interact with system 106 via a computing device, including but not limited to a personal computer, a tablet computer, a smartphone, an kiosk, an appliance, a television, or any other device capable of an operable coupling to system 106. Interfaces provided to the different devices and/or entities included in exemplary environment 100 may be provisioned in hardware, software, firmware, or some combination of the above. The choice and manner of implementation of such interfaces is well known in the art and will be within the capability of those with skill in the art, and will not be discussed further herein. In different embodiments, a participant 11N, the advertiser 130, an insurer 140, and the supplier of a prize 120 may relay information among the entities included in exemplary environment 100 by a voice link or in person. The devices and/or entities included in the exemplary environment 100 may be operably coupled via some network or combination of networks (e.g. the internet, a wireless network, an intranet, etc.). The operable couplings between the devices and/or entities may be tangible connections (e.g., wires and/or cables and/or fiber optic lines), or intangible connections (e.g., wireless connections, e.g. radio-frequency connections between cell phone and cell network towers, e.g. a wireless network adapter and a wireless access point or wireless router), and/or some combination of tangible and intangible connections.

Following are a series of flowcharts depicting implementations of processes. For ease of understanding, the flowcharts are organized such that the initial flowcharts present implementations via an overall “big picture” viewpoint and thereafter the following flowcharts present alternate implementations and/or expansions of the “big picture” flowcharts as either sub-steps or additional steps building on one or more earlier-presented flowcharts. Those having skill in the art will appreciate that the style of presentation utilized herein (e.g., beginning with a presentation of flowchart(s) presenting an overall view and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

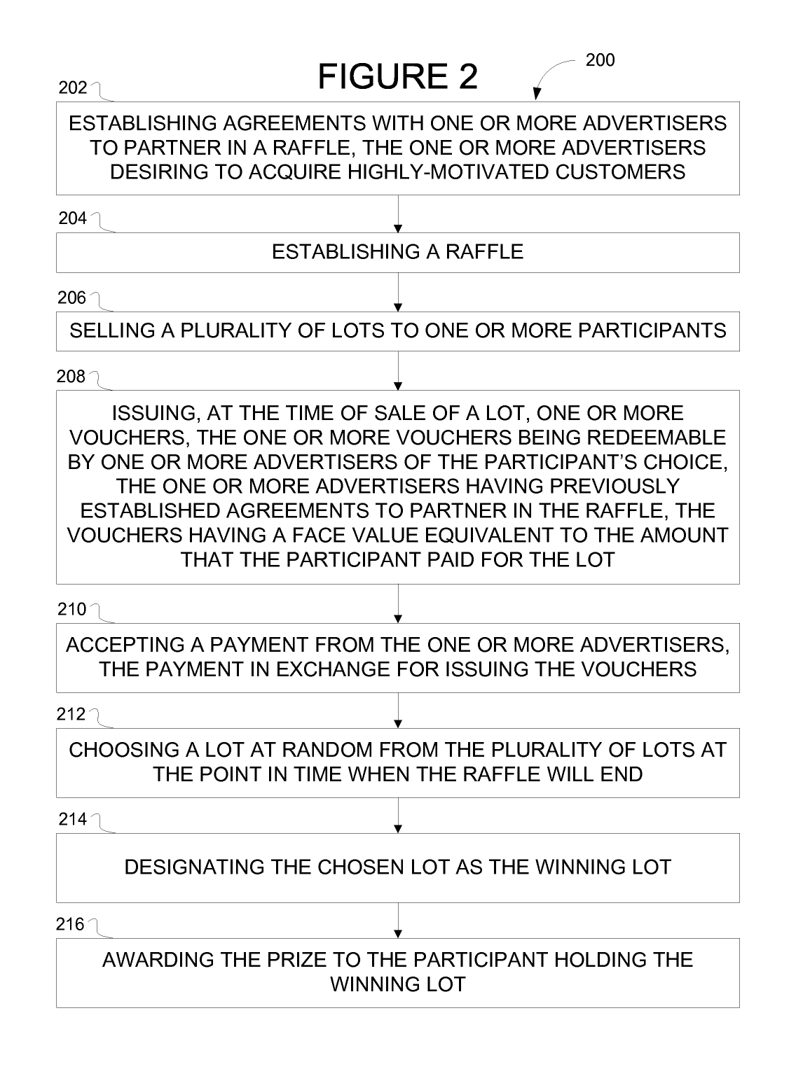

FIG. 2 depicts a high-level logic flowchart of an operational process. The illustrated process 200 may include operation 202, operation 204, operation 206, operation 208, operation 210, operation 212, operation 214 and/or operation 216.

Operation 202 illustrates establishing agreements with one or more advertisers to partner in a raffle, the one or more advertisers desiring to acquire highly-motivated customers. Operation 202 may include, for example, establishing an agreement with an advertiser 130, where the advertiser 130 is a merchant desiring to acquire highly-motivated customers. The agreement to partner in a raffle may comprise an agreement on the part of the advertiser 130 to honor a voucher that will be issued by the system 106 to a raffle participant 11N, the voucher being in an amount equal to the amount the raffle participant 11N paid to enter a raffle to win a prize 120. In certain embodiments, the voucher is redeemable by the raffle participant 11N for a discount at advertiser 130 in conjunction with a purchase by the raffle participant 11N.

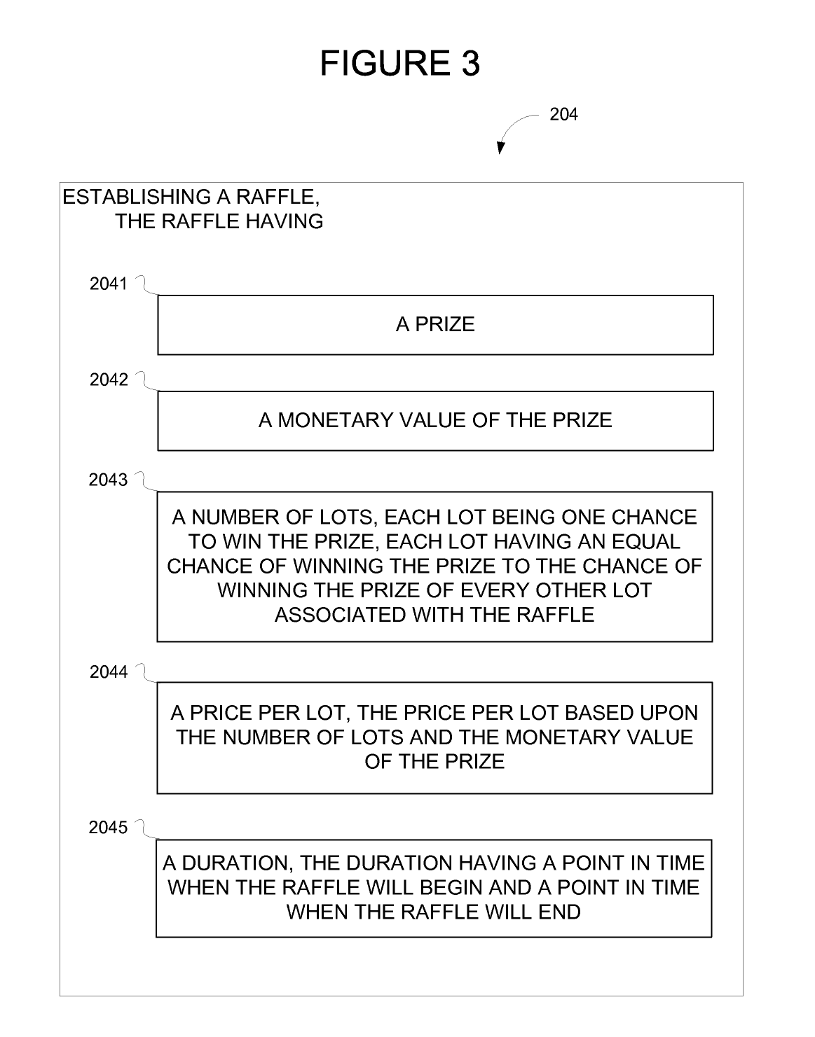

Operation 204 illustrates establishing a raffle. Operation 204 is illustrated in more detail in FIG. 3. In some implementations, a raffle includes a prize 2041, where a prize can be goods, services, cash, or anything of value as previously disclosed herein. The prize 2041 has a monetary value 2042 assigned to it. In different implementations, the monetary value 2042 of the prize 2041 can be the manufacturer's suggested retail price (MSRP) of the prize 2041, or any other price representing the monetary value 2042 of the prize 2041 can be assigned.

A raffle may also include a predetermined number of lots 2043, each lot of the number of lots 2043 representing one chance to win the prize 2041. Each lot in the number of lots 2043 has an equal chance of winning the prize as every other lot. The number of lots 2043 represents the maximum number of chances to win the prize 2041 that will be sold during the course of the raffle. A raffle may also have a price per lot 2044. In certain embodiments, the price per lot 2044 may be established by dividing the monetary value of the prize 2042 by the number of lots 2043. In other embodiments the price per lot 2044 may be established differently.

A raffle may also include a duration 2045, the duration 2045 having a point in time when the raffle will begin, and a point in time when the raffle may end. Lots may be sold during the raffle duration 2045, the sale of lots beginning at the point in time when the raffle will begin, and continuing up until the point in time when the raffle will end. In some embodiments, the point in time when the raffle will end is fixed, i.e. the raffle ends on that predetermined date irrespective of whether all of the number of lots 2043 have been sold.

In different embodiments, a raffle established by the establishing a raffle step at 204 is a state lottery, in which participants who purchase lottery tickets may, in addition to the chance of winning the lottery jackpot, also receive value for the purchase price of the lottery tickets. In some implementations, lottery ticket purchasers receive vouchers redeemable by an advertiser 130. In different implementations, the establishing a raffle step at 204 includes establishing any game of chance in which one or more participants 110 can win a prize 120.

Returning to FIG. 2, at operation 206, the step of selling a plurality of lots to one or more participants 206 is depicted. In some embodiments, lots may be sold at any time during the raffle duration 2045, the sale of lots ending at the point in time when the raffle may end.

Operation 208 illustrates issuing, at the time of sale of a lot, one or more vouchers, the one or more vouchers being redeemable by one or more advertisers 130 of the participant's 11N choice, the one or more advertisers having previously established agreements to partner in the raffle at 202, the vouchers having a face value equivalent to the amount that the participant paid for the lot. In some embodiments, the participant 11N is offered vouchers from one or more advertisers 130, each advertiser 130 having entered into an agreement to partner into the raffle. In this manner, the participant 11N is likely to be able to find an advertiser 130 with whom to redeem a voucher that sells goods or services that the participant 11N was likely to purchase anyway. Thus, participant 11N sees a no-risk proposition in terms of being able to enter a raffle, garnering the excitement of the possibility of winning a prize 120, while spending money at an advertiser 130 on goods or services the participant 11N was likely to acquire anyway. For the advertiser 130, who is essentially offering participant 11N a discount in the amount of the face value of the raffle entry to acquire participant 11N as a customer, the advertiser 130 will acquire that customer in a more cost-effective manner than spending advertising dollars on traditional advertising venues.

Operation 210 illustrates accepting a payment from the one or more advertisers, the payment in exchange for issuing the vouchers. In some embodiments, an advertiser 130 may pay a fee for partnering in the raffle, where the fee may be a percent of the voucher amount, or some other fixed amount per voucher, or any other fee determined in advance when the advertiser enters into the agreement to partner in the raffle. In some embodiments, an advertiser 130 may pay no fee, pay a fee of zero or have fees waived entirely for partnering in the raffle.

Operation 212 illustrates choosing a lot at random from the plurality of lots at the point in time when the raffle will end. Operation 214 illustrates designating the chosen lot as the winning lot. Operation 216 illustrates awarding the prize to the participant holding the winning lot. In some embodiments, the winner, i.e. the participant 11N who holds the lot that was designated as the winning lot, may still redeem the voucher received at the time of purchase of the lot at the advertiser 130. Participants 11N who did not win the raffle and who do not hold the winning lot may also still redeem their vouchers received at the time of purchase of their lots.

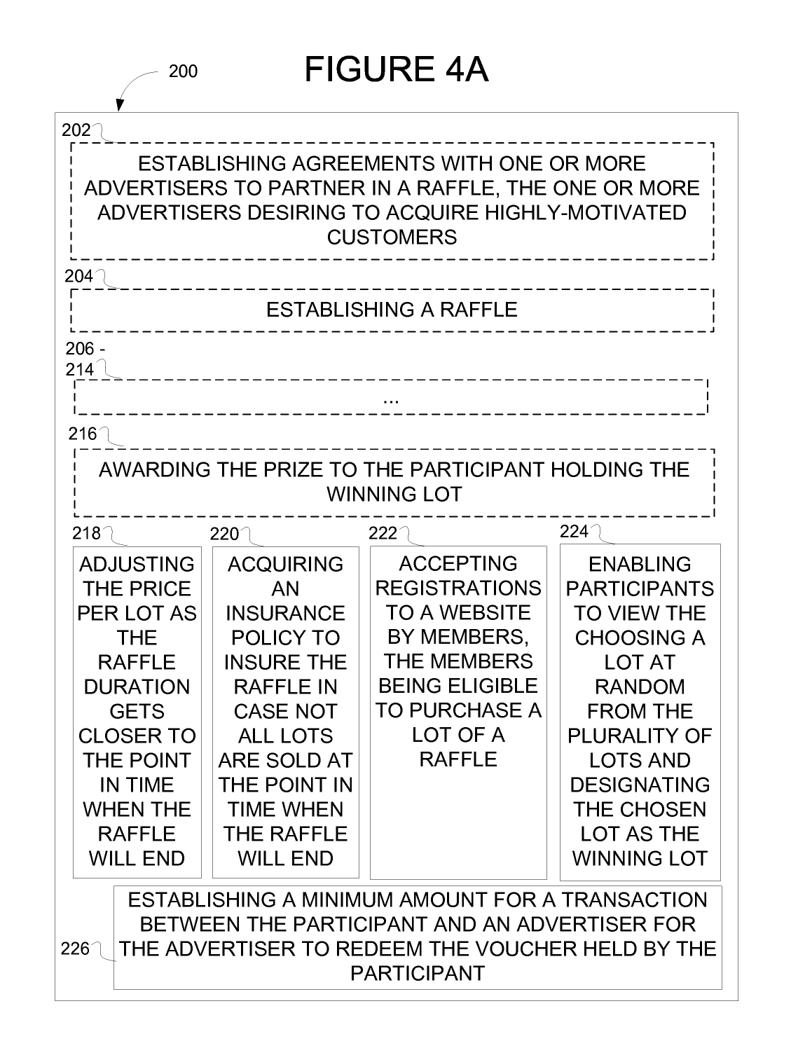

FIG. 4 depicts several alternative implementations of the high-level logic flowchart of FIG. 2. The depicted process may include one or more of the following operations: operations 200 through 216 (described elsewhere herein), operation 218, operation 220, operation 222, operation 224 and/or operation 226.

Operation 218 illustrates adjusting the price per lot as the raffle duration gets closer to the point in time when the raffle will end. In some embodiments, as the raffle nears the end, if a certain number of lots has not been sold, the price may be adjusted to spur sales of more lots. For example, in a ten-day raffle (beginning at day 1 and ending on day 10) having 100 lots available at $10 each, if by day 7 only 10 lots have been sold, the price of a lot may be reduced to $8. In some embodiments, the voucher that is issued that is redeemable at an advertiser 130 is still issued having a face value equivalent to the amount spent on the lot. Thus, in the foregoing example, even if the original price of a lot is $10, if the participant 11N ultimately spends only $8 on the lot, the amount redeemable by an advertiser 130 is also $8. In different embodiments, the price of a lot may be adjusted at any time during the raffle to any price according to a formula, taking into account the number of lots having been sold to date. In certain embodiments, the price of a lot may be adjusted upward or downward.

Operation 220 illustrates acquiring an insurance policy to insure the raffle in case not all lots are sold at the point in time when the raffle will end. In some embodiments, if efforts at adjusting the price per lot as the raffle duration gets closer to the point in time when the raffle will end at 218 do not achieve the goal of selling all the raffle lots, the net revenue from the sale of the lots that were sold will not be enough to cover the cost of the prize 120. However, in most jurisdictions by law a raffle must still have a prize giveaway at the end, even when not enough lots are sold. Thus, an insurance policy insuring against not having enough lots sold can be purchased from an insurer 140 to manage this risk. In different embodiments, even if all the lots are sold, they were sold a low enough price to sell all the lots but insufficiently high to cover the cost of the prize 120. Again, an insurance policy insuring against not having taken in enough revenue from the sale of the lots can be purchased from an insurer 140 to manage this risk.

Operation 222 illustrates accepting registrations to a website by members, the members being eligible to purchase a lot of a raffle. In some embodiments, only registered members of a website may participate in a raffle. In some embodiments, anyone can browse the website to see the list of advertisers 130 or the list of raffles established by step 204. In other embodiments, to participate in the raffle, one must register as a member of the website. In some embodiments, a registration requires providing contact information to the website. In different embodiments, a registration requires providing demographic information to the website. In certain embodiments, becoming a registered member of the website requires a paid membership. In different embodiments, registered members of the website receive periodic emails or newsletters containing information regarding new advertisers 130, new raffles, promotions being run by particular advertisers 130 (e.g. double-redemption of vouchers during certain dates) or other information of interest to members.

Operation 224 illustrates enabling participants 11N to view the choosing a lot at random from the plurality of lots and designating the chosen lot as the winning lot. In other words, participants 11N, who may have registered as members of a website, may be provided with a URL and/or password tied to a particular raffle, where the members can browse to the URL at a particular date and time and watch a live drawing of the winning lot of the raffle.

Operation 226 illustrates establishing a minimum amount for a transaction between the participant 11N and an advertiser 130 for the advertiser 130 to redeem the voucher held by the participant 11N. In some embodiments, an advertiser 130 may require a voucher to be less than a particular percentage of the total transaction amount. For example, an advertiser 130 may wish to effectively provide no more than a 20% discount on the transaction. Accordingly, an advertiser 130 may require that a $10 voucher must be used on at least a $50 transaction with the advertiser 130.

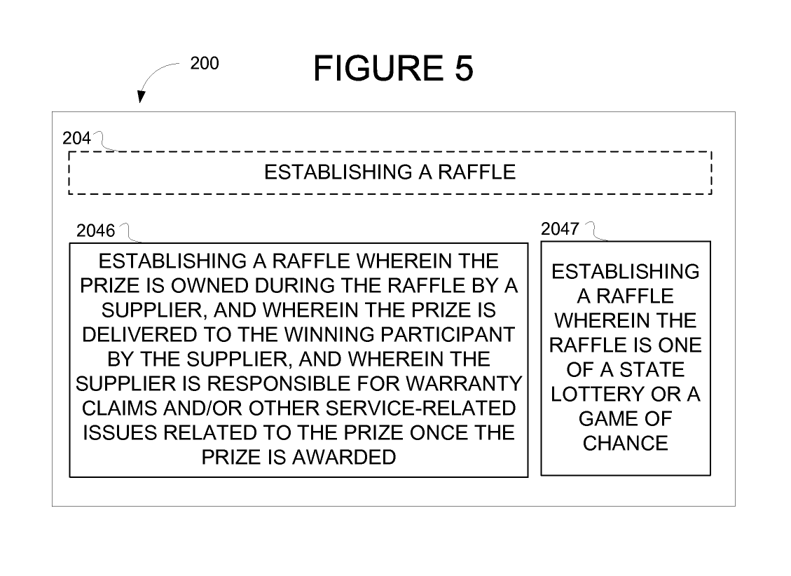

FIG. 5 depicts several alternative implementations of the high-level logic flowchart of FIG. 2. The depicted process may include one or more of the following operations: operations 204 (described elsewhere herein), operation 2046 and/or operation 2047.

Operation 2046 illustrates establishing a raffle wherein the prize 120 is owned during the raffle by a supplier, and wherein the prize 120 is delivered to the winning participant 11N by the supplier, and wherein the supplier is responsible for warranty claims and/or other service-related issues related to the prize 120 once the prize 120 is awarded.

Operation 2047 illustrates establishing a raffle wherein the raffle is one of a state lottery or a game of chance. In some embodiments, a state lottery may enter into an agreement to partner in a raffle. In different embodiments, a state lottery may be unconnected to the raffle, but advertisers agree to honor vouchers issued in conjunction with state lottery tickets purchased. Participants 11N who purchase lottery tickets may, in addition to the chance of winning the lottery jackpot, also receive value for the purchase price of the lottery tickets. In some implementations, lottery ticket purchasers receive vouchers redeemable by an advertiser 130. In different implementations, operation 2047 includes establishing a raffle wherein the raffle is any game of chance in which one or more participants 110 can win a prize 120.

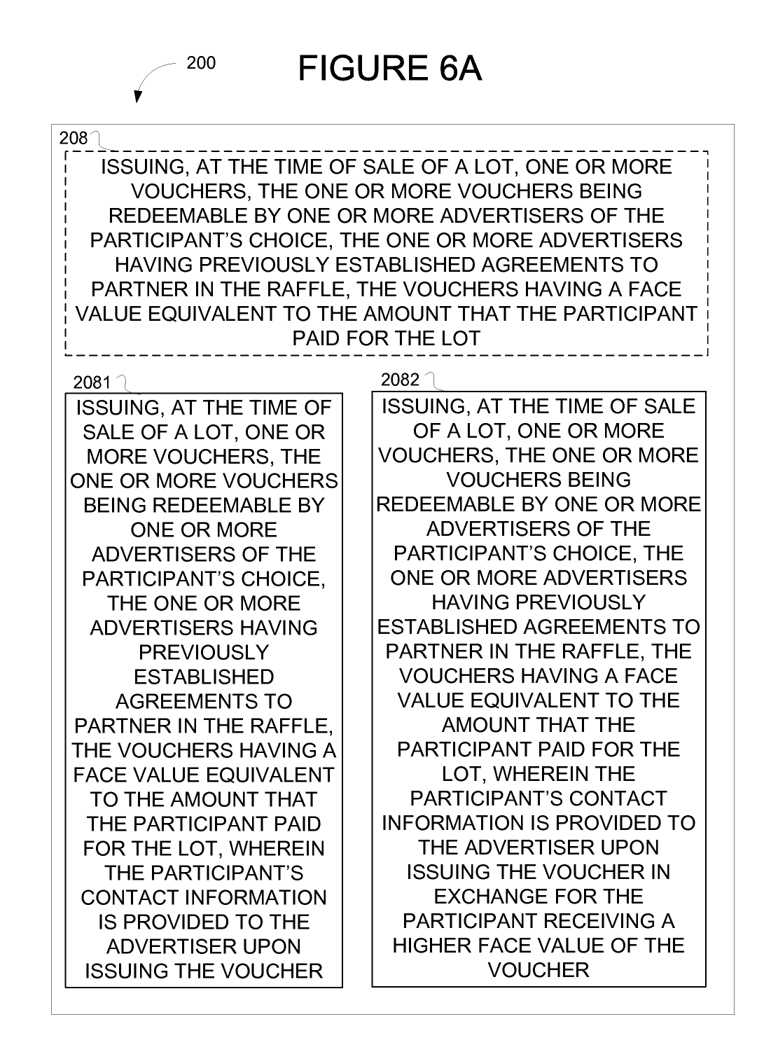

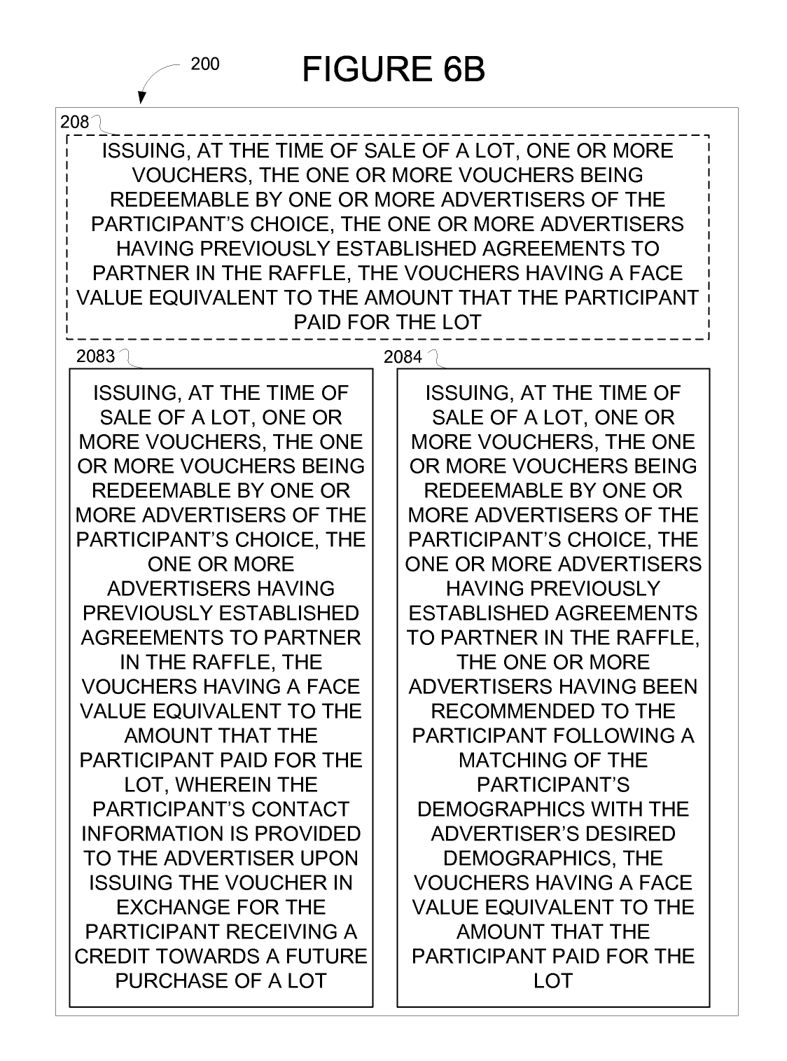

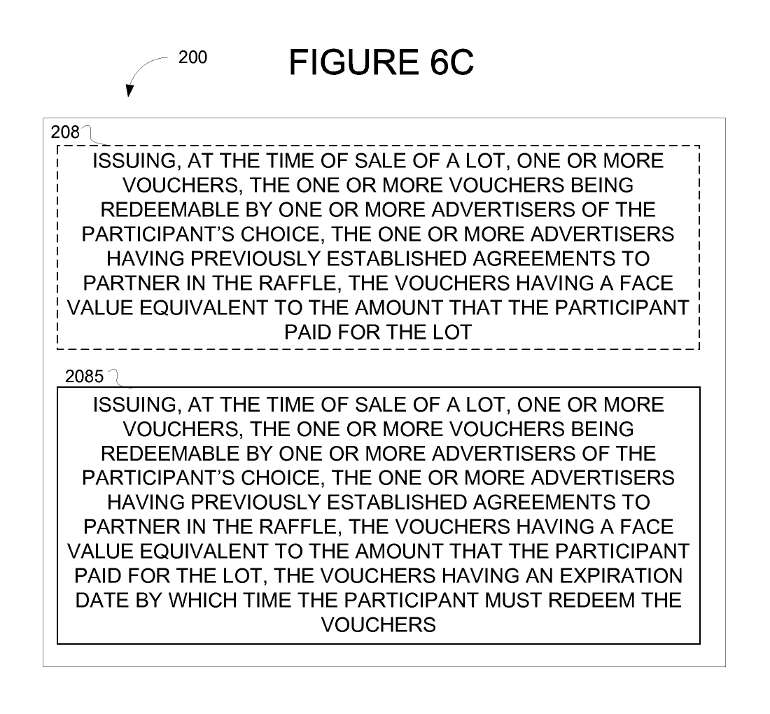

FIGS. 6A-6C depict several alternative implementations of the high-level logic flowchart of FIG. 2. The depicted processes may include one or more of the following operations: operation 208 (described elsewhere herein), operation 2081, operation 2082, operation 2083, operation 2084 and/or operation 2085.

Operation 2081 illustrates issuing, at the time of sale of a lot, one or more vouchers, the one or more vouchers being redeemable by one or more advertisers 130 of the participant's 11N choice, the one or more advertisers 130 having previously established agreements to partner in the raffle, the vouchers having a face value equivalent to the amount that the participant 11N paid for the lot, wherein the participant's 11N contact information is provided to the advertiser 130 upon issuing the voucher. In certain embodiments, an advertiser 130 may also receive the contact information for a participant 11N. In some embodiments, the contact information for the participant 11N is only received by the advertiser 130 when a transaction includes a voucher that is redeemed. An advertiser 130 may wish to maintain contact information for the participant 11N so that the advertiser 130 may continue a relationship with the participant 11N to ensure that the advertiser 130 retains the participant 11N that the advertiser 130 paid to acquire as a customer through the redemption of the voucher. In some embodiments, providing contact information is a term of becoming a member of a website where raffles are established.

Operation 2082 illustrates issuing, at the time of sale of a lot, one or more vouchers, the one or more vouchers being redeemable by one or more advertisers 130 of the participant's 11N choice, the one or more advertisers 130 having previously established agreements to partner in the raffle, the vouchers having a face value equivalent to the amount that the participant 11N paid for the lot, wherein the participant's 11N contact information is provided to the advertiser 130 upon issuing the voucher in exchange for the participant 11N receiving a higher face value of the voucher. In certain embodiments, a participant 11N may not necessarily want to provide an advertiser 130 with contact information. In some embodiments, an advertiser 130 may want to entice the participant 11N to provide contact information, and can do so by offering a higher face value of the voucher for redemption with the advertiser 130 in exchange for the participant's 11N contact information.

Operation 2083 illustrates issuing, at the time of sale of a lot, one or more vouchers, the one or more vouchers being redeemable by one or more advertisers 130 of the participant's 11N choice, the one or more advertisers 130 having previously established agreements to partner in the raffle, the vouchers having a face value equivalent to the amount that the participant 11N paid for the lot, wherein the participant's 11N contact information is provided to the advertiser 130 upon issuing the voucher in exchange for the participant 11N receiving a credit towards a future purchase of a lot. In certain embodiments, a participant 11N may not necessarily want to provide an advertiser 130 with contact information. In some embodiments, a participant 11N can be enticed to provide contact information by receiving a credit towards a future purchase of a lot in a different raffle in exchange for the participant's 11N contact information.

Operation 2084 illustrates issuing, at the time of sale of a lot, one or more vouchers, the one or more vouchers being redeemable by one or more advertisers of the participant's choice, the one or more advertisers having previously established agreements to partner in the raffle, the one or more advertisers having been recommended to the participant following a matching of the participant's demographics with the advertiser's desired demographics, the vouchers having a face value equivalent to the amount that the participant paid for the lot. At the time when the participant 11N enters the raffle by purchasing a lot, in some embodiments the participant 11N may be able to select a particular advertiser 130 from a list of advertisers 130 who have entered into agreements to partner in the raffle. In certain embodiments, the participant 11N may have been required to provide demographic information when the participant 11N registered as a member on a website through which one or more participants 110 bid on raffles. At operation 2084, when a participant 11N is shown a list of advertisers 130 offering to redeem vouchers, the list of advertisers 130 may be seeded with advertisers 130 whose demographics of desired customers match the demographics of the participant 11N.

Operation 2085 illustrates issuing, at the time of sale of a lot, one or more vouchers, the one or more vouchers being redeemable by one or more advertisers 130 of the participant's 11N choice, the one or more advertisers 130 having previously established agreements to partner in the raffle, the vouchers having a face value equivalent to the amount that the participant 11N paid for the lot, the vouchers having an expiration date by which time the participant 11N must redeem the vouchers. In some embodiments, an advertiser 130 may wish to employ an expiration date by which time the voucher must be redeemed by the participant 11N as a method of ensuring that the participant 11N becomes a customer in a timely fashion.

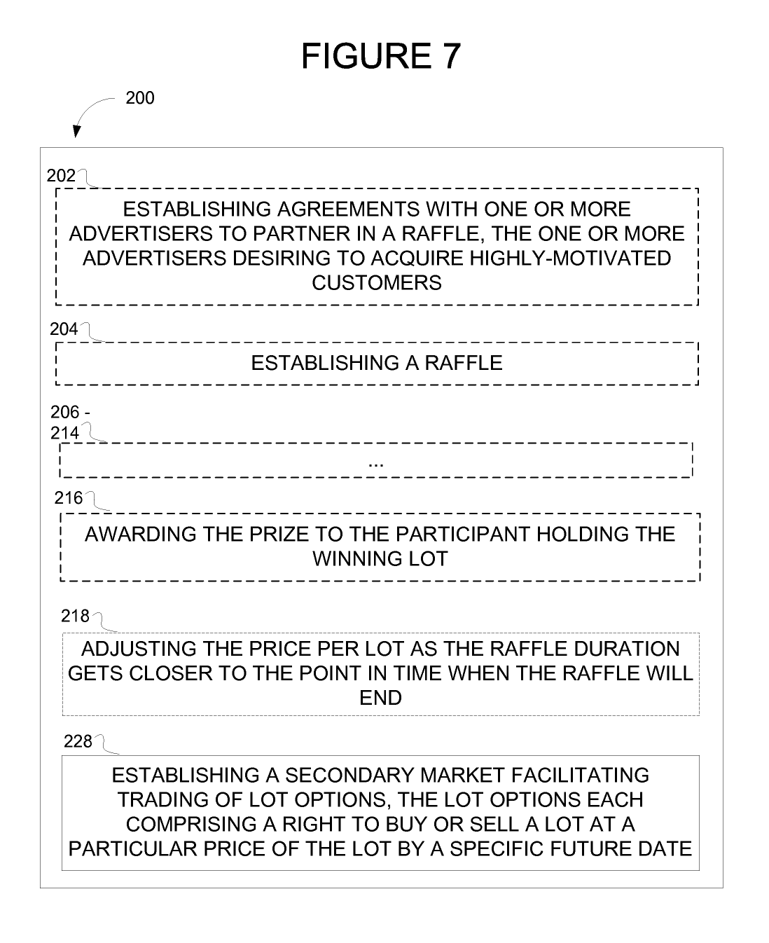

FIG. 7 depicts an alternative implementation of the high-level logic flowchart of FIG. 2. The depicted process may include one or more of the following operations: operations 200 through 218 (described elsewhere herein), and/or operation 228.

Operation 228 illustrates establishing a secondary market facilitating trading of lot options, the lot options each comprising a right to buy or sell a lot at a particular price of the lot by a specific future date. In some embodiments, a participant 11N, a member of the website, or another person may wish to engage in a transaction with a different participant 11N, member of the website or other person in which the parties agree to exchange a lot for a particular price by a specific future date. As the price of a lot is varied at operation 218, parties may enter into secondary contracts for lots at future times. Analogous to an options market, those who enjoy the excitement of the possibility of winning a prize through a raffle might enjoy options trading for lots even further. Additionally, the establishment of a secondary options market for raffle lots opens up the appeal to an additional class of users who may not be interested in entering a raffle for a prize, but who might be interested in options trading in a unique class of investment. Further, establishing a secondary market facilitating trading of lot options may also include receiving a payment for each contract that is established by parties that comprises the rights of parties to buy or sell a lot at a particular price at a specific future date.

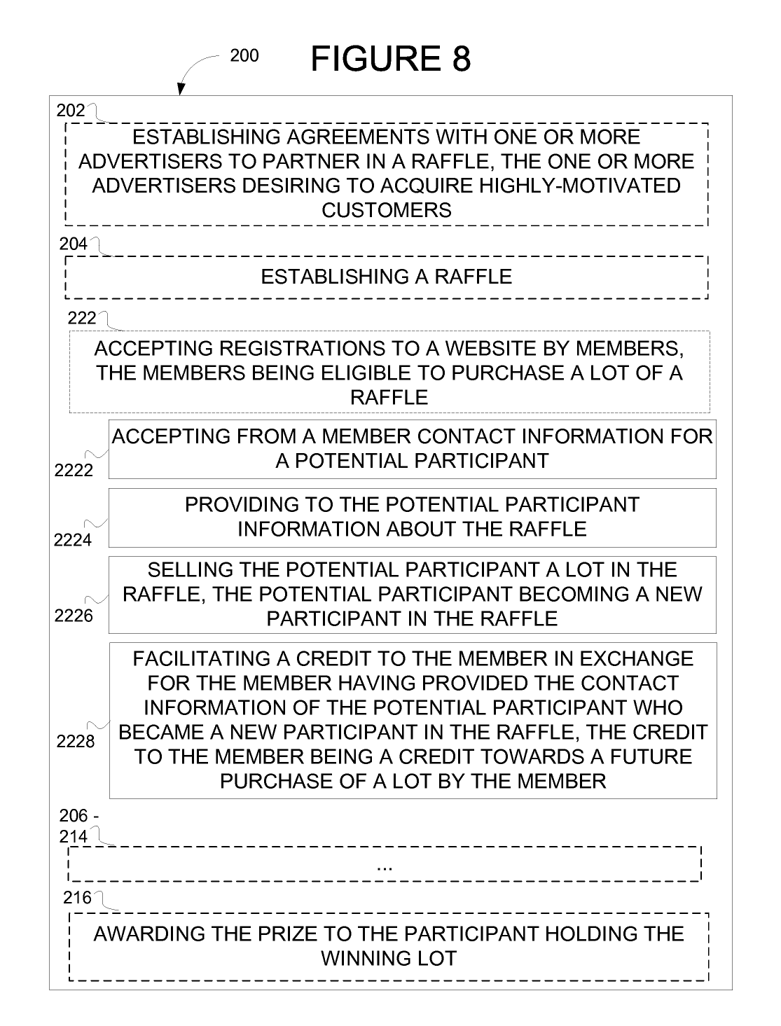

FIG. 8 depicts an alternative implementation of the high-level logic flowchart of FIG. 2. The depicted process may include one or more of the following operations: operations 200 through 216 (depicted elsewhere herein), operation 222 (depicted elsewhere herein), operation 2222, operation 2224, operation 2226, and/or operation 2228.

Operation 2222 illustrates accepting from a member contact information for a potential participant. In some embodiments, members of the website who see a raffle on the website that is a particularly interesting or attractive raffle may wish to let their friends know about the raffle. For example, a member of the website may be aware of a raffle currently underway such as a ten-day raffle (beginning at day 1 and ending on day 10) having 100 lots available at $10 each, where on day 9 only 10 lots have been sold. The member may believe this is an attractive raffle. It may be an attractive raffle because if by the end of the raffle only another 5 tickets are sold, a participant's 11N chance of winning goes from 1 in 100 to 1 in 15. A member may wish to make a friend aware of the attractive raffle. The friend may or may not be a member of the website, although if the friend is not a member of the website, the friend may join the website in order to participate in the attractive raffle. Therefore, in some embodiments, operation 2222 may include accepting from the member of the website contact information for a potential participant, where the potential participant may be a friend of the member of the website and the contact information for the potential participant may include an email address.

Operation 2224 illustrates providing to the potential participant information about the raffle. For example, if at operation 2222 the member of the website has provided an email address for the potential participant, the potential participant may be sent an email. The email may include the recommendation of the member-friend that the potential participant visit the website, if necessary become a member of the website, and look at the raffle. In this way, viral marketing for the raffles and the website can be implemented.

Operation 2226 illustrates selling the potential participant a lot in the raffle, the potential participant becoming a new participant 11N in the raffle. In some embodiments, if the potential participant was not a member of the website, the viral marketing method has acquired a new member for the website.

Operation 2228 illustrates facilitating a credit to the member in exchange for the member having provided the contact information of the potential participant who became a new participant in the raffle, the credit to the member being a credit towards a future purchase of a lot by the member. In some embodiments, if a member recommends a raffle to a friend and that friend joins the website and/or enters the raffle, the member can receive a credit towards the future purchase of a lot. In this manner, the viral marketing for the raffles and the website can be accelerated.

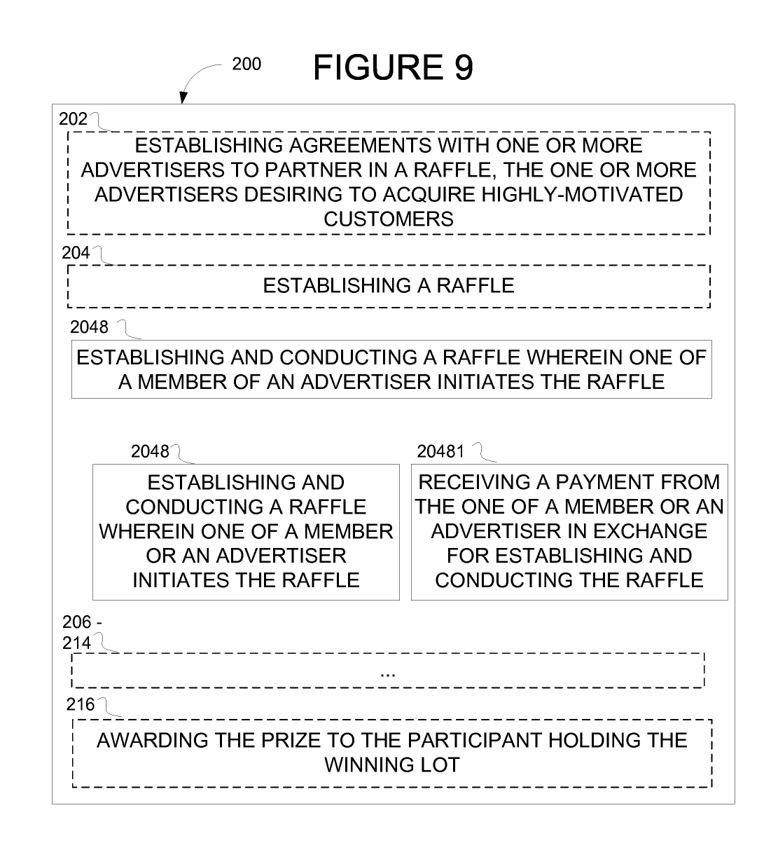

FIG. 9 depicts several alternative implementations of the high-level logic flowchart of FIG. 2. The depicted process may include one or more of the following operations: operations 202-216 (depicted elsewhere herein), operation 2048 and/or operation 20481.

Operation 2048 illustrates establishing and conducting a raffle wherein one of a member or an advertiser 130 initiates the raffle. In some embodiments, raffles can be established at the request of a member or an advertiser 130, where the member or advertiser 130 owns the prize 120 and facilitates the awarding (i.e. delivery and service) of the prize 120 to the winning participant 11N.

Operation 20481 illustrates receiving a payment from the one of a member or an advertiser 130 in exchange for establishing and conducting the raffle. In some embodiments, if a member or an advertiser 130 requests to establish a raffle, a payment may be received from the member or advertiser 130 in exchange for establishing and conducting the raffle. Establishing and conducting raffles for website members or advertisers 130 represents an additional revenue stream in terms of the payments from members or advertisers 130 for establishing and conducting raffles. An advertiser 130 may also choose to raffle off one of its own goods as a method of increasing its visibility among the members of the website and/or the one or more participants 110.

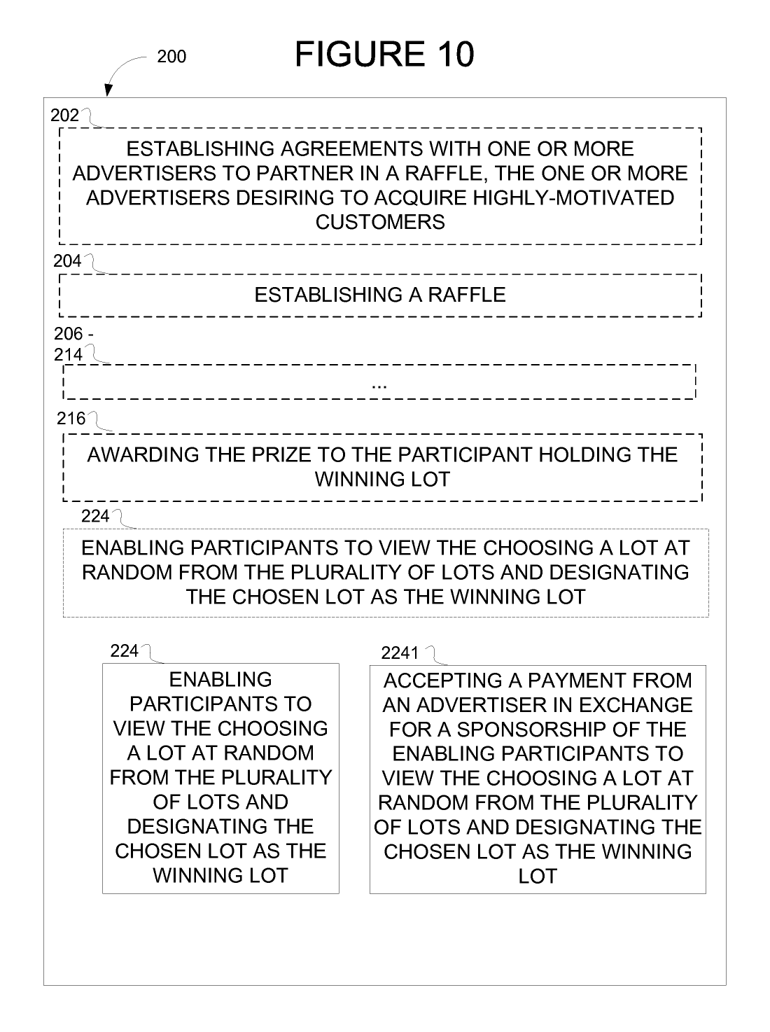

FIG. 10 depicts an alternative implementation of the high-level logic flowchart of FIG. 2. The depicted process may include one or more of the following operations: operations 202-216 (depicted elsewhere herein), operation 224 (depicted elsewhere herein) and/or operation 2241.

Operation 2241 illustrates accepting a payment from an advertiser 130 in exchange for a sponsorship of the enabling participants to view the choosing a lot at random from the plurality of lots and designating the chosen lot as the winning lot. In embodiments where participants 11N are given a URL and/or password to view a live drawing of the winning lot, the live drawing of the winning lot may be sponsored by a particular advertiser 130 in exchange for a payment from the advertiser 130.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method of facilitating customer acquisition for advertisers, comprising the steps of:
establishing agreements with one or more advertisers to partner in a raffle, the one or more advertisers desiring to acquire highly-motivated customers;
establishing a raffle, the raffle having:
a prize;
a monetary value of the prize;
a number of lots, each lot being one chance to win the prize, each lot having an equal chance of winning the prize to the chance of winning the prize of every other lot associated with the raffle;
a price per lot, the price per lot based upon the number of lots and the monetary value of the prize; and
a duration, the duration having a point in time when the raffle will begin and a point in time when the raffle will end;
selling a plurality of lots to one or more participants;
issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot;
accepting a payment from the one or more advertisers, the payment in exchange for issuing the vouchers;
choosing a lot at random from the plurality of lots at the point in time when the raffle will end;
designating the chosen lot as the winning lot; and
awarding the prize to the participant holding the winning lot;
wherein at least one of the establishing agreements, establishing a raffle, selling lots, issuing vouchers, accepting a payment, choosing a lot, designating the chosen lot, or awarding the prize is implemented using one or more microprocessors.

2. The method of claim 1, further comprising the step of adjusting the price per lot as the raffle duration gets closer to the point in time when the raffle will end.

3. The method of claim 1, further comprising the step of acquiring an insurance policy to insure the raffle in case not all lots are sold at the point in time when the raffle will end.

4. The method of claim 1, further comprising the step of accepting registrations to a website by members, the members being eligible to purchase a lot of a raffle.

5. The method of claim 1, further comprising the step of enabling participants to view the choosing a lot at random from the plurality of lots and designating the chosen lot as the winning lot.

6. The method of claim 1, further comprising the step of establishing a minimum amount for a transaction between the participant and an advertiser for the advertiser to redeem the voucher held by the participant.

7. The method of claim 1, wherein the step of establishing a raffle further comprises:
establishing a raffle wherein the prize is owned during the raffle by a supplier, and wherein the prize is delivered to the winning participant by the supplier, and wherein the supplier is responsible for warranty claims and/or other service-related issues related to the prize once the prize is awarded.

8. The method of claim 1, wherein the step of establishing a raffle further comprises:
establishing a raffle wherein the raffle is one of a state lottery or a game of chance.

9. The method of claim 1, wherein the step of issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot further comprises:
issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot, wherein the participant's contact information is provided to the advertiser upon issuing the voucher.

10. The method of claim 1, wherein the step of issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot further comprises:
issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot, wherein the participant's contact information is provided to the advertiser upon issuing the voucher in exchange for the participant receiving a higher face value of the voucher.

11. The method of claim 1, wherein the step of issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot further comprises:
issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot, wherein the participant's contact information is provided to the advertiser upon issuing the voucher in exchange for the participant receiving a credit towards a future purchase of a lot.

12. The method of claim 1, wherein the step of issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot further comprises:
issuing, at the time of a sale of a lot, one or more vouchers, the one or more vouchers being redeemable by one or more advertisers of the participant's choice, the one or more advertisers having previously established agreements to partner in the raffle, the one or more advertisers having been recommended to the participant following a matching of the participant's demographics with the advertiser's desired demographics, the vouchers having a face value equivalent to the amount that the participant paid for the lot.

13. The method of claim 1, wherein the step of issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot further comprises:
issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot, the vouchers having an expiration date by which time the participant must redeem the vouchers.

14. The method of claim 2, further comprising the step of establishing a secondary marketplace facilitating trading of lot options, the lot options each comprising a right to buy or sell a lot at a particular price of the lot by a specific future date.

15. The method of claim 4, further comprising the steps of:
accepting from a member contact information for a potential participant;
providing to the potential participant information about the raffle;
selling the potential participant a lot in the raffle, the potential participant becoming a new participant in the raffle;
facilitating a credit to the member in exchange for the member having provided the contact information of the potential participant who became a new participant in the raffle, the credit to the member being a credit towards a future purchase of a lot by the member.

16. The method of claim 4, wherein the step of establishing a raffle further comprises:
establishing and conducting a raffle wherein one of a member or an advertiser initiates the raffle.

17. The method of claim 16, wherein the step of establishing and conducting a raffle wherein one of a member or an advertiser initiates the raffle further comprises:
establishing and conducting a raffle wherein one of a member or an advertiser initiates the raffle; and
receiving a payment from the one of a member or an advertiser in exchange for establishing and conducting the raffle.

18. The method of claim 5, wherein the step of enabling participants to view the choosing a lot at random from the plurality of lots and designating the chosen lot as the winning lot further comprises:
enabling participants to view the choosing a lot at random from the plurality of lots and designating the chosen lot as the winning lot; and
accepting a payment from an advertiser in exchange for a sponsorship of the enabling participants to view the choosing a lot at random from the plurality of lots and designating the chosen lot as the winning lot.

19. A system comprising:
circuitry for establishing agreements with one or more advertisers to partner in a raffle, the one or more advertisers desiring to acquire highly-motivated customers;
circuitry for establishing a raffle, the raffle having:
a prize;
a monetary value of the prize;
a number of lots, each lot being one chance to win the prize, each lot having an equal chance of winning the prize to the chance of winning the prize of every other lot associated with the raffle;
a price per lot, the price per lot based upon the number of lots and the monetary value of the prize; and
a duration, the duration having a point in time when the raffle will begin and a point in time when the raffle will end;
circuitry for selling a plurality of lots to one or more participants;
circuitry for issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot;
circuitry for accepting a payment from the one or more advertisers, the payment in exchange for issuing the vouchers;
circuitry for choosing a lot at random from the plurality of lots at the point in time when the raffle will end;
circuitry for designating the chosen lot as the winning lot; and
circuitry for awarding the prize to the participant holding the winning lot.

20. A system comprising:
means for establishing agreements with one or more advertisers to partner in a raffle, the one or more advertisers desiring to acquire highly-motivated customers;
means for establishing a raffle, the raffle having:
a prize;
a monetary value of the prize;
a number of lots, each lot being one chance to win the prize, each lot having an equal chance of winning the prize to the chance of winning the prize of every other lot associated with the raffle;
a price per lot, the price per lot based upon the number of lots and the monetary value of the prize; and
a duration, the duration having a point in time when the raffle will begin and a point in time when the raffle will end;
means for selling a plurality of lots to one or more participants;
means for issuing, at the time of a sale of a lot, one or more vouchers, the one or more vouchers being redeemable by one or more advertisers of the participant's choice, the one or more advertisers having previously established agreements to partner in the raffle, the vouchers having a face value equivalent to the amount that the participant paid for the lot;
means for accepting a payment from the one or more advertisers, the payment in exchange for issuing the vouchers;
means for choosing a lot at random from the plurality of lots at the point in time when the raffle will end;
means for designating the chosen lot as the winning lot; and
means for awarding the prize to the participant holding the winning lot.
